(19) United States
(12) Patent Application Publication
(10) Pub. No.: US 2009/0264011 A1
(43) Pub. Date: Oct. 22, 2009

(54) HIGH FREQUENCY DIGITAL A/V CABLE CONNECTOR AND CABLE ASSEMBLY

(75) Inventor: Chang-Pin Wang, Yung-Ho City (TW)

Correspondence Address: SURE-FIRE ELECTRICAL CORPORATION, 2F-4, NO. 148, SEC. 4, CHUNG HSIAD E. ROAD, TAIPEI, TW

(73) Assignee: SURE-FIRE ELECTRICAL CORPORATION, Hsinchuang City (TW)

(21) Appl. No.: 12/254,827

(22) Filed: Oct. 20, 2008

(30) Foreign Application Priority Data
Apr. 17, 2008 (TW) 097206574

(51) Int. Cl. H01R 31/08

(52) U.S. Cl. 439/507

(57) ABSTRACT

A high frequency digital A/V cable connector assembly includes a cable connector, which is connectable to an electronic apparatus and has first and second conducting terminals arranged in two horizontal rows, an adapter board, which has first metal contacts and jumper circuits arranged on the top side for the bonding of the first conducting terminals of the cable connector, second metal contacts arranged on the bottom side for the bonding of the second conducting terminals of the cable connector and respectively electrically connected to the jumper circuits, and bonding contacts electrically connected with the first metal contacts and the jumper circuits, and a cable, which has core wires respectively bonded to the jumper circuits.

This application claims the priority benefit of Taiwan patent application number 097206574 filed on Apr. 17, 2008.

### BACKGROUND OF THE INVENTION

1. Field of the Invention

The present invention relates to electrical connectors and more particularly, to a high frequency digital A/V cable connector, which utilizes an adapter board for quick bonding of the connector to a cable, improving the productivity and signal transmission quality and saving much the installation cost.

2. Description of the Related Art

In recent years, audio and video application designs have been well developed. Nowadays, many audio and video products, such as VCD, DVD, digital versatile disc, high-definition digital TV, videophone, video conference system and the like are now common in our daily life. When compared to conventional techniques, these new system architectures utilize digital technology to process voice and image data. Subject to different requirements for application in different fields, different standards are established, modified and updated to improve digital signal transmission (without compression) in speed and quality so that people can enjoy better quality of audio and video.

DisplayPort, DVI and HDMI are digital video interface standards designed to maximize the visual quality of digital display devices. A DisplayPort, DVI or HDMI connector is connectable to an adapter, set-top box, DVD player, PC, TV game machine, synthesized amplifier or digital audio equipment for long distance application to transmit audio video signals stably at a high speed, satisfying consumers' requirements.

A DisplayPort, DVI or HDMI connector can be used with a round or flat cable. When connecting a DisplayPort, DVI or HDMI connector to a cable, a circuit board is provided at the connector and electrically connected to the internal conducting terminals of the connector for the bonding of the transmission wires of the cable. However, the configuration of the conducting terminals of a DisplayPort, DVI or HDMI connector, the configuration of the metal contacts of the circuit board and the pin configuration of the cable to be connected are different. During installation, the transmission wires of the cable must be bonded to the respective metal contacts at the circuit board one after another in a proper order for perfect match. In order to approach one transmission wire to the matching metal contact at the circuit board, the transmission wire may have to be biased and tangled with other transmission wires. This mounting procedure is complicated, wasting much labor and time. Further, keeping transmission wires in a tangle relatively lowers the signal transmission quality.

Therefore, it is desirable to provide a measure that eliminates the aforesaid drawbacks.

### SUMMARY OF THE INVENTION

The present invention has been accomplished under the circumstances in view. A high frequency digital A/V cable connector, which allows quick bonding of the connector with a high frequency digital A/V cable by means of an automatic wire bonder, improving the productivity and signal transmission quality and saving much the installation cost.

To achieve this and other objects of the present invention, the high frequency digital A/V cable assembly comprises a high frequency digital A/V cable connector and a high frequency digital A/V cable. The high frequency digital A/V cable connector comprises a connector connectable to an electronic apparatus, and an adapter board connected to the connector for the bonding of a high frequency digital A/V cable. The connector has embedded therein first conducting terminals and second conducting terminals arranged in two horizontal rows. The adapter board comprises a plurality of first metal contacts and jumper circuits arranged on the top side for the bonding of the first conducting terminals of the connector, a plurality of second metal contacts arranged on the bottom side for the bonding of the second conducting terminals of the connector and respectively electrically connected to the jumper circuits, and a plurality of bonding contacts electrically connected with the first metal contacts and the jumper circuits. The adapter board and the connector can easily be connected together by means of bonding the first metal contacts and second metal conducts of the adapter board to the first conducting terminals and second conducting terminals of the connector automatically through an automatic wire bonder.

According to another aspect of the present invention, the high frequency digital A/V cable is a flat cable, comprising a plurality of core wires arranged in parallel, and the pin configuration of the bonding contacts of the adapter board matches the pin configuration of the high frequency digital A/V cable so that the cable can be bonded to the adapter board automatically through an automatic wire bonder, improving the productivity and signal transmission quality and saving much the installation cost.

### BRIEF DESCRIPTION OF THE DRAWINGS

FIG. 1 is an elevational of a high frequency digital A/V cable assembly in accordance with the present invention.

FIG. 2 is an exploded view of high frequency digital A/V cable assembly shown in FIG. 1.

FIG. 3 corresponds to FIG. 2 when viewed from another angle.

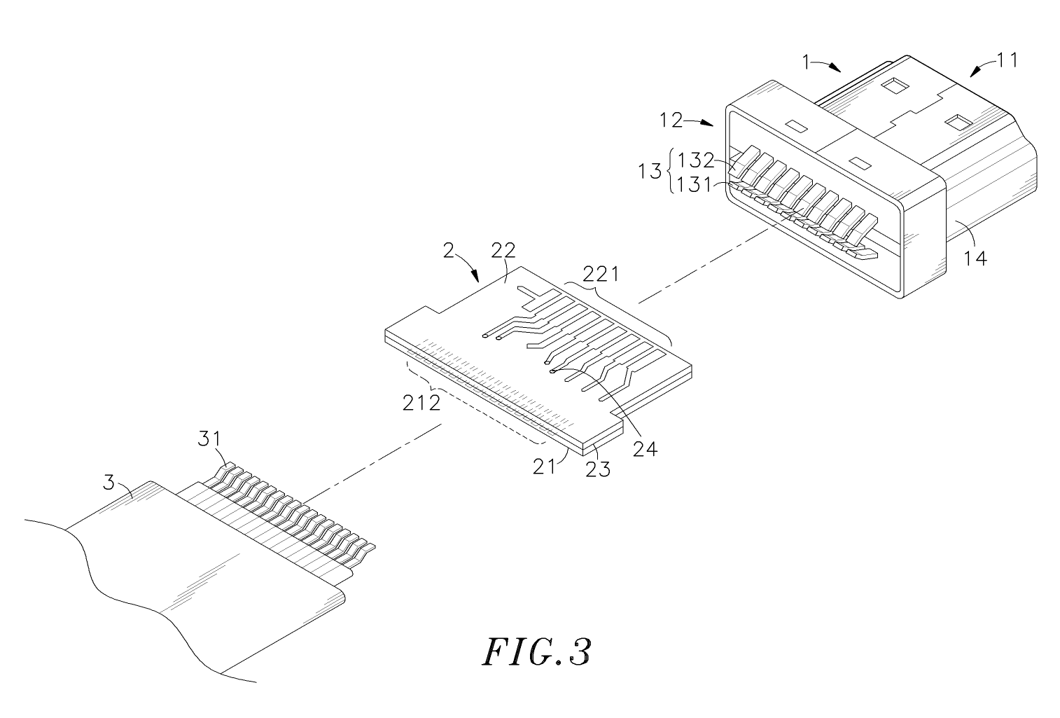

FIG. 4 is a pin configuration diagram of the high frequency digital A/V cable assembly in accordance with the present invention.

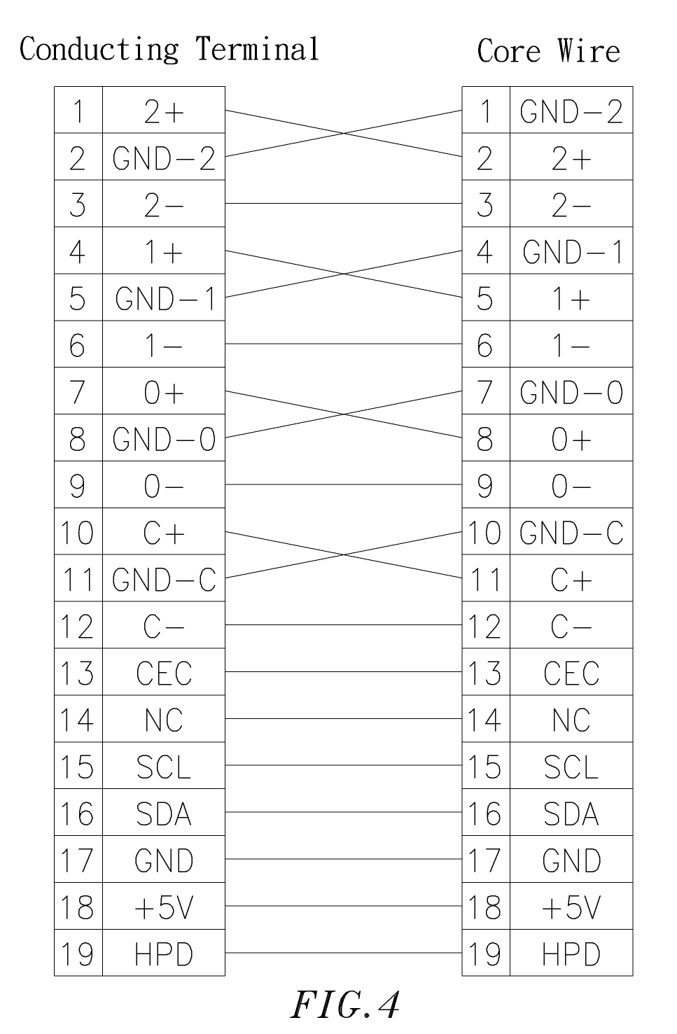

FIG. 5 is a schematic sectional side view of the present invention before bonding of the core wires of the cable to the bonding contacts of the adapter board.

FIG. 6 corresponds to FIG. 5, showing the core wires of the cable bonded to the bonding contacts of the adapter board.

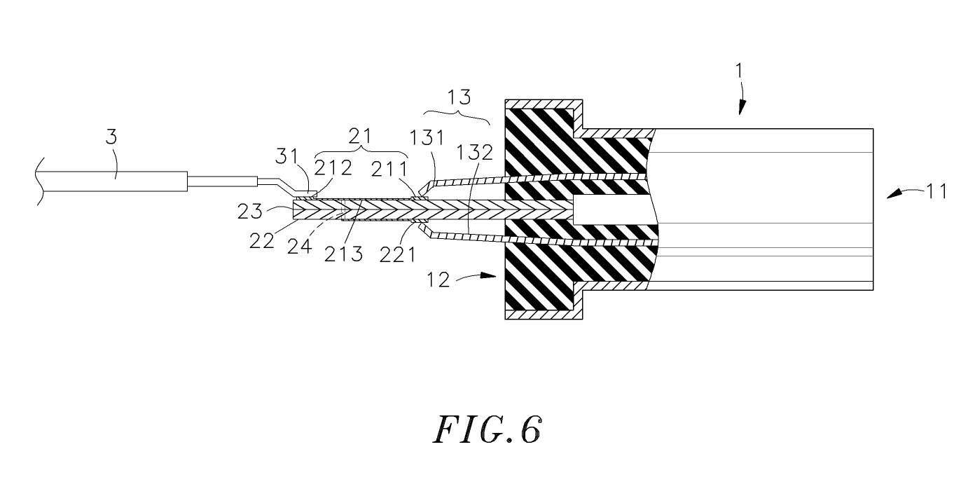

FIG. 7 is an exploded view of an alternate form of the high frequency digital A/V cable assembly in accordance with the present invention.

### DETAILED DESCRIPTION OF THE PREFERRED EMBODIMENT

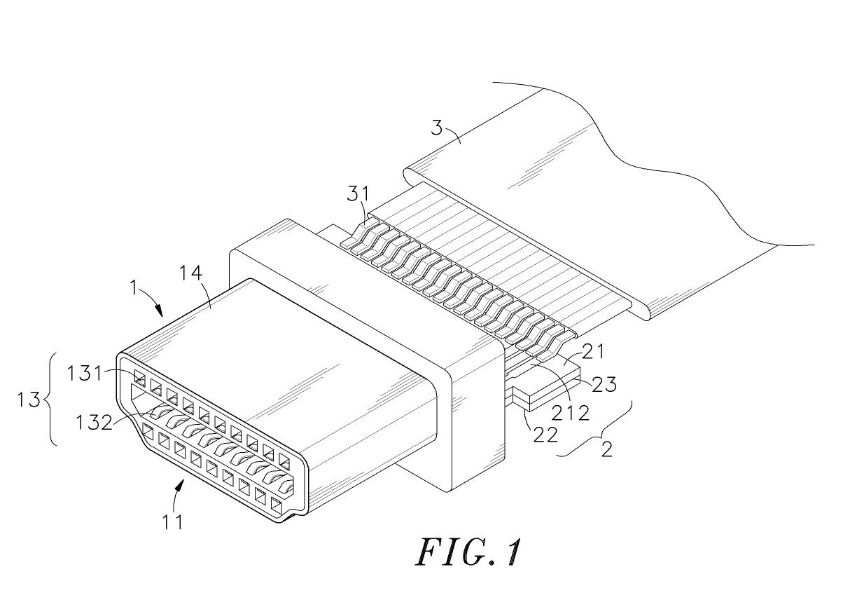

Referring to FIGS. 1˜4, a high frequency digital A/V cable assembly 1 in accordance with the present invention is shown comprised of a cable connector 1, an adapter board 2 and a cable 3.

The cable connector 1 comprises an abutting end 11 disposed at its one side and connectable to an external electronic apparatus (not shown), a bonding end 12 disposed at its other side, and a conducting terminal set 13 embedded therein. The conducting terminal set 13 comprises a plurality of first conducting terminals 131 and a plurality of second conducting terminals 132 arranged in two rows at two different elevations and respectively extending from the abutting end 11 to the outside of the bonding end 12.

The adapter board 2 comprises a first surface 21, a second surface 22 opposite to the first surface 21, a plurality of first metal contacts 211 arranged on the first surface 21 for the bonding of the first conducting terminals 131 respectively, a plurality of second metal contacts 221 arranged on the second surface 22 for the bonding of the second conducting terminals 132 respectively, a plurality of jumper circuits 213 arranged on the first surface 21 and respectively electrically connected with the second metal contacts 221 at the second surface 22, and a plurality of bonding contacts 212 respectively electrically connected with the first metal contacts 211 and the jumper circuits 213 for the bonding of the core wires 31 of the cable 3 (see FIG. 1).

The first conducting terminals 131 and the plurality of second conducting terminals 132 are embedded in the cable connector 1 without changing their respective extending direction.

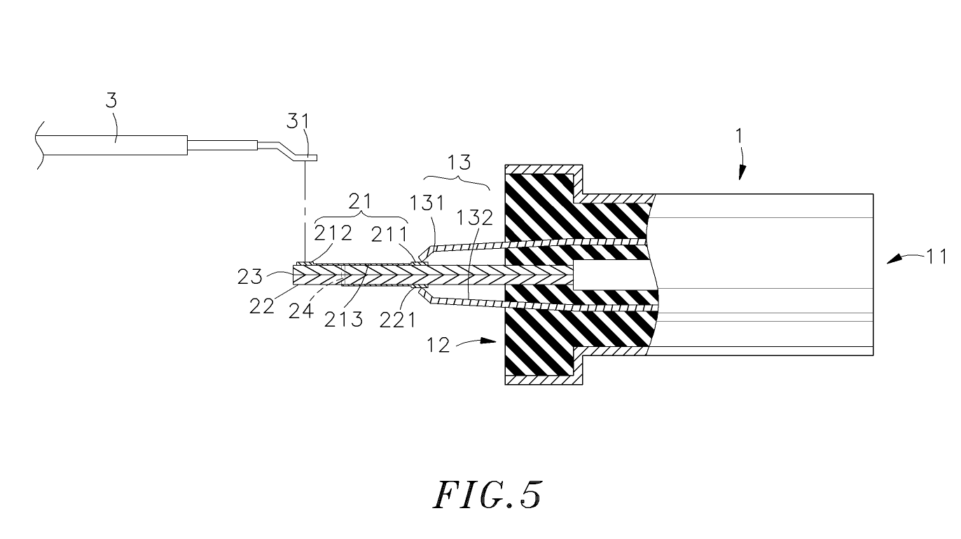

During installation, the adapter board 2 is bonded to the bonding end 12 of the cable connector 1 at first. At this time, the first surface 21 of the adapter board 2 is attached to the first conducting terminals 131 to force the first metal contacts 211 into contact with the first conducting terminals 131 respectively (see FIG. 5), and at the same time the second surface 22 of the adapter board 2 is attached to the second conducting terminals 132 to force the second metal contacts 221 into contact with the second conducting terminals 132 respectively. Thereafter, the core wires 31 of the cable 3 are respectively attached to the bonding contacts 212 of the adapter board 2 in a perfect match.

After match of the conducting terminal set 13 of the cable connector 1 with the metal contacts 211 and 221 of the adapter board 2 and match of the bonding contacts 212 of the adapter board 2 with the core wires 31 of the cable 3, an automatic wire bonding machine is operated to perform a single-sided bonding operation and to electrically connect the cable connector 1, the adapter board 2 and the cable 3 together.

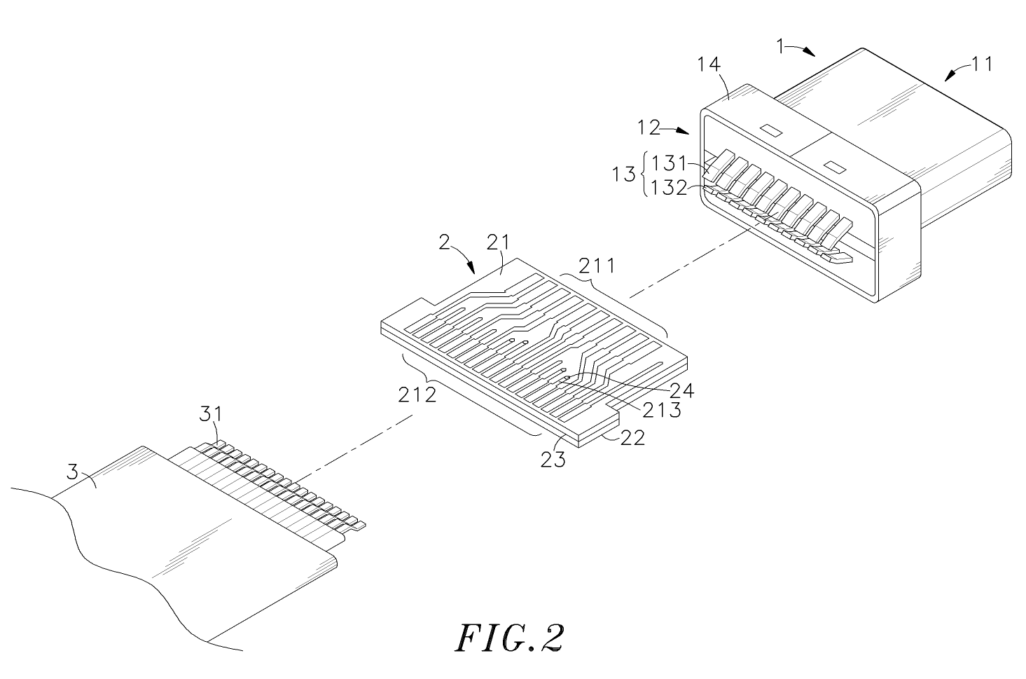

Further, the adapter board 2 comprises a metal ground plane 23. After connection of the abutting end 11 of the cable connector 1 to an external electronic product, the metal ground plane 23 of the adapter board 2 insolates interference produced during signal transmission through the circuits on the top and bottom sides of the adapter board 2 (see FIG. 2), lowering crosstalk noise. Further, the adapter board 2 itself has electromagnetic wave isolation function. Therefore, the invention provides enhanced EMI protection.

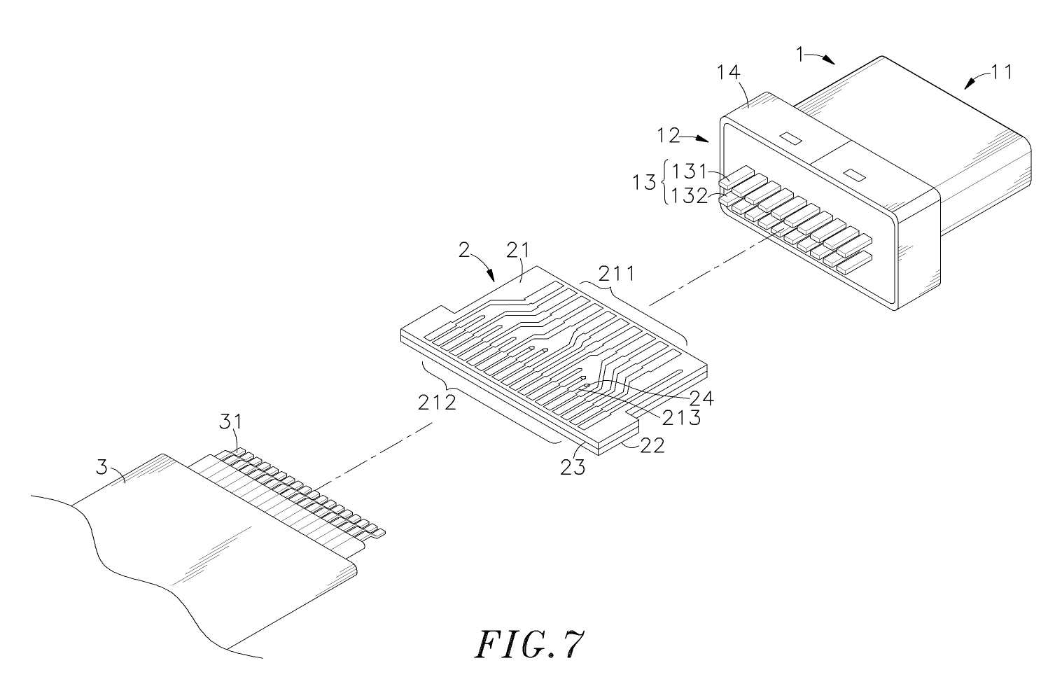

Referring to FIG. 7, the gap between the upper row of first conducting terminals 131 and bottom row of second conducting terminals 132 of the conducting terminal set 13 of the cable connector 1 can be designed subject to the thickness of the adapter board 2. Further, the first conducting terminals 131 and the second conducting terminals 132 horizontally extend out of the bonding end 12 at two different elevations. During installation, the adapter board 2 is directly inserted into the space between the first conducting terminals 131 and the second conducting terminals 132. After insertion of the adapter board 2 into the space between the first conducting terminals 131 and the second conducting terminals 132, the first conducting terminals 131 and the second conducting terminals 132 are respectively attached to the respective contacts at the adapter board 2, and thus the first conducting terminals 131 and second conducting terminals 132 of the cable connector 1 can be directly bonded to the adapter board 2 by an automatic bonding machine, saving much the installation time.

Further, the adapter board 2 further comprises a plurality of via holes 24 electrically connected between the first metal contacts 211 and the second metal contacts 221. The via holes 24 are respectively located on the rear ends of the jumper circuits 213 of the first metal contacts 211 and cut through the wall thickness of the adapter board 2 and respectively electrically connected to the second metal contacts 221 at the second surface 22 of the adapter board 2. By means of the via holes 24, crosstalk noise is guided from the grounding wire of the cable 3 to the metal ground plane 23 of the adapter board 2 and then eliminated. Therefore, audio and video signals are stably transmitted through the cable 3, the adapter board 2 and the cable connector 1 to the electronic apparatus for output, enabling the electronic apparatus to display high quality images.

Further, the adapter board 2 can be multilayer circuit board in which circuit means is arranged in between the first surface 21 and the second surface 22 to electrically connect the first metal contacts 211 and the second metal contacts 221.

Further, the cable connector 1 may be covered with a metal shield 14 (see FIG. 2) for protection against interference of external electromagnetic waves. Further, according to the present preferred embodiment, the cable connector 1 is a male connector. However, this is not a limitation. Alternatively, the cable connector 1 can be made in the form of a female connector.

Further, the cable connector 1 can be a DisplayPort connector, DVI (Digital Visual Interface) connector or HDMI (high-definition multimedia interface) connector. In case the cable connector 1 is a DVI connector, it has at least 24 pins. When the cable connector 1 is a DisplayPort connector, it has 20 pins. If the cable connector 1 is a HDMI connector, it has 19 pins. By means of configuration conversion through the adapter board 2, the cable connector 1, either in HDMI, DisplayPort or DVI form, can be connected to the cable 1 by means of pin-insertion bonding or surface mounting technique.

Further, the cable 3 can be a flat cable type high frequency signal line for bonding to the adapter board 2 at the cable connector 1. During installation, the core wires 31 of the cable 3 are directly attached to the bonding contacts 212 of the adapter board 2 in a match, and then an automatic wire bonding machine is operated to perform a single-sided bonding process. This installation procedure suits for automated processing, improving the productivity and signal transmission quality and saving much the installation cost.

Thus, during connection between the cable 3 and the cable connector 1, the adapter board 2 is used to match the cable 3 and the cable connector 1 for bonding. By means of the matching design between the adapter board 2 and the cable 3 and the matching design between the adapter board 2 and the cable connector 1, the cable 3 and the cable connector 1 are electrically connected together. By means of the configuration matching design between the bonding contacts 212 of the adapter board 2 and the core wires 31 of the cable 3, direct alignment is easily done for quick bonding, avoiding tangling of the core wires 31 during bonding and saving much the installation time. Therefore, the invention has good applicability and high expansibility characteristics. Further, the modularized design of the present invention is suitable for mass production to save the cost.

The scope of the present invention to be protected is that the adapter board 2 comprises a first surface 21, a second surface 22 opposite to the first surface 21, a plurality of first metal contacts 211 for the bonding of the first conducting terminals 131 of the cable connector 1 respectively, a plurality of second metal contacts 221 arranged on the second surface 22 for the bonding of the second conducting terminals 132 of the cable connector 1 respectively, a plurality of jumper circuits 213 respectively extending from the first metal contacts 211 at the first surface 21 and respectively electrically connected with the second metal contacts 221 at the second surface 22, and a plurality of bonding contacts 212 respectively extended from the first metal contacts 211 and arranged in an array for the bonding of the core wires 31 of the cable 3. The structural design of the adapter board 2 allows quick bonding between the cable 3 and the adapter board 2 and between the cable connector 1 and the adapter board by means of an automatic wire bonder, assuring excellent bonding quality for high quality signal transmission and saving much the installation time.

In conclusion, the technical features of the present invention that improve the prior art designs are that the adapter board 2 has its first metal contacts 211 and second metal contacts 221 arranged to match the first conducting terminals 131 and second conducting terminals 132 of the cable connector 1 respectively, and its first metal contacts 211 and jumper circuits 213 electrically connected to the bonding contacts 212 in an array for the bonding of the core wires 31 of the cable 3 automatically through a single-sided bonding technique, assuring excellent bonding quality for high quality signal transmission and saving much the installation time to raise the productivity and to lower the cost.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A high frequency digital A/V cable connector comprising:
a connector, said connector comprising an abutting end disposed at a first side thereof and connectable to an external electronic apparatus, a bonding end disposed at a second side thereof, and a conducting terminal set embedded therein and extending from said abutting end through said bonding end to the outside of said second end, said conducting terminal set comprising a plurality of first conducting terminals and a plurality of second conducting terminals arranged in two rows at two different elevations; and
an adapter board, said adapter board comprising a first surface, a second surface opposite to said first surface, a plurality of first metal contacts arranged on said first surface and respectively bonded to the first conducting terminals of said connector, a plurality of second metal contacts arranged on said second surface and respectively bonded to the second conducting terminals of said connector, a plurality of jumper circuits respectively arranged on said first surface and respectively electrically connected with said second metal contacts, and a plurality of bonding contacts respectively electrically connected with said first metal contacts and said jumper circuits and arranged at a rear side of said adapter board.

2. The high frequency digital A/V cable connector as claimed in claim 1, where said first conducting terminals are respectively arranged in a parallel manner relative to said second conducting terminals.

3. The high frequency digital A/V cable as claimed in claim 1, wherein said adapter board is a multilayer circuit board.

4. The high frequency digital A/V cable connector as claimed in claim 1, wherein said adapter board comprises a plurality of via holes respectively electrically connected between said first metal contacts and said second metal contacts.

5. The high frequency digital A/V cable connector as claimed in claim 1, wherein said connector comprises metal shield covered thereon.

6. The high frequency digital A/V cable connector as claimed in claim 1, wherein said connector is a HDMI (high-definition multimedia interface) male connector.

7. The high frequency digital A/V cable connector as claimed in claim 1, wherein said connector is a DisplayPort male connector.

8. The high frequency digital A/V cable connector as claimed in claim 1, wherein said connector is a DVI (digital visual interface) male connector.

9. A high frequency digital A/V cable connector comprising:
a connector, said connector comprising an abutting end disposed at a first side thereof and connectable to an external electronic apparatus, a bonding end disposed at a second side thereof, and a conducting terminal set embedded therein and extending from said abutting end through said bonding end to the outside of said second end, said conducting terminal set comprising a plurality of first conducting terminals and a plurality of second conducting terminals arranged in two rows at two different elevations;
an adapter board, said adapter board comprising a first surface, a second surface opposite to said first surface, a plurality of first metal contacts arranged on said first surface and respectively bonded to the first conducting terminals of said connector, a plurality of second metal contacts arranged on said second surface and respectively bonded to the second conducting terminals of said connector, a plurality of jumper circuits respectively arranged on said first surface and respectively electrically connected with said second metal contacts, and a plurality of bonding contacts respectively electrically connected with said first metal contacts and said jumper circuits and arranged at a rear side of said adapter board; and
a cable, said cable comprising a plurality of core wires respectively bonded to said bonding contacts of said adapter board through a single-sided bonding technique.

10. The high frequency digital A/V cable connector as claimed in claim 9, where said first conducting terminals are respectively arranged in a parallel manner relative to said second conducting terminals.

11. The high frequency digital A/V cable as claimed in claim 9, wherein said adapter board is a multilayer circuit board.

12. The high frequency digital A/V cable connector as claimed in claim 9, wherein said adapter board comprises a plurality of via holes respectively electrically connected between said first metal contacts and said second metal contacts.

13. The high frequency digital A/V cable connector as claimed in claim 9, wherein said connector comprises metal shield covered thereon.

14. The high frequency digital A/V cable connector as claimed in claim 9, wherein said connector is a HDMI (high-definition multimedia interface) male connector.

15. The high frequency digital A/V cable connector as claimed in claim 9, wherein said connector is a DisplayPort male connector.

16. The high frequency digital A/V cable connector as claimed in claim 9, wherein said connector is a DVI (digital visual interface) male connector.

17. The high frequency digital A/V cable connector as claimed in claim 9, wherein said cable is a flat cable.
